(19) United States
(12) Patent Application Publication
(10) Pub. No.: US 2011/0266838 A1
(43) Pub. Date: Nov. 3, 2011

(54) FLOOR STRUCTURE OF A MOTOR VEHICLE BODY

(75) Inventor: Frank LEOPOLD, Taunusstein-Orlen (DE)

(73) Assignee: GM GLOBAL TECHNOLOGY OPERATIONS LLC, Detroit, MI (US)

(21) Appl. No.: 13/095,645

(22) Filed: Apr. 27, 2011

(30) Foreign Application Priority Data
Apr. 28, 2010 (DE) 102010018481.0

(51) Int. Cl. B62D 25/20

(52) U.S. Cl. 296/193.07; 296/204

(57) ABSTRACT

A floor structure is provided for a motor vehicle body having a central tunnel, which extends essentially in the vehicle longitudinal direction and protrudes upward in the direction of a passenger compartment located above it, and having at least one transverse tunnel, which extends transversely to the central tunnel, and extends from the central tunnel up to an edge located in the vehicle transverse direction.

### CROSS-REFERENCE TO RELATED APPLICATION

This application claims priority to German Patent Application No. 102010018481.0, filed Apr. 28, 2010, which is incorporated herein by reference in its entirety.

### TECHNICAL FIELD

The technical field relates to a floor structure of a motor vehicle body, a corresponding motor vehicle body, and a correspondingly implemented motor vehicle.

### BACKGROUND

The optimum possible utilization of the installation space available in a motor vehicle, in particular in a passenger automobile implemented as a compact car, which is limited in any case, receives increased significance during the redevelopment of vehicles. Optimized installation space utilization plays a dominant role in particular in compact and ultra-compact vehicles solely because of the comparatively small external dimensions of the vehicle.

Furthermore, hybrid drive concepts, in which internal combustion engines are coupled to alternative drives, in particular electric motors, place further demands with respect to the installation space allocation of the motor vehicle. Furthermore, in known drive concepts for compact vehicles, a substantial weight component of the vehicle drive is located in front of the front axle of the motor vehicle, which overall can result in deficiencies of the space utilization and the vehicle driving behavior. The geometric dimensions of drives, such as engines and transmissions, require positioning in front of the front axle of the vehicle. In addition, the vehicle radiator is to be situated mounted in front of the drive on the vehicle front because of the required fresh air supply. Furthermore, self-supporting vehicle bodies for motor vehicles typically have a floor structure extending between front frame and rear frame in the area below their passenger compartment. Rear frame and front frame are connected directly or indirectly to one another via the interposed floor structure via longitudinal girders and side sills, for example. In addition, a central tunnel is provided in the area of the middle vehicle floor, which contributes to stiffening of the floor plate, on the one hand, and is used as a housing for further vehicle components, for the vehicle transmission, for example, on the other hand.

The floor plate which predominantly spans the floor structure is implemented as substantially level and comparatively thin-walled. Therefore, it only contributes to the stability of the floor structure to a limited extent. Supporting and structure-reinforcing vehicle body components, such as longitudinal girders and side sills, in contrast, are implemented as comparatively thick-walled and are manufactured from materials having a comparatively high density, preferably from steel plate.

Therefore, at least one object is to provide an installation space concept, which is improved in particular with respect to compact cars, and an improved floor structure of a motor vehicle body suitable for this purpose. The floor structure is to be distinguished in this case by increased stability and torsion stiffness and improved torque resistance and is to have the lowest possible weight. The floor structure is additionally to allow improved weight distribution and center of gravity displacement of the motor vehicle. Furthermore, other objects, desirable features and characteristics will become apparent from the subsequent summary and detailed description, and the appended claims, taken in conjunction with the accompanying drawings and this background.

### SUMMARY

A floor structure is provided for a motor vehicle body, in particular a self-supporting motor vehicle body, which has a central tunnel extending essentially in the vehicle longitudinal direction. This tunnel protrudes upward in relation to an adjoining floor plate, namely in the direction of a passenger compartment above it. The central tunnel thus forms a depression in the floor structure of the motor vehicle body which protrudes in the direction of the vehicle vertical axis.

Furthermore, at least one transverse tunnel extending transversely to the central tunnel is provided, which extends from the central tunnel up to an edge of the floor structure in the vehicle transverse direction. The central tunnel preferably directly adjoins the central tunnel in this case and extends in the vehicle transverse direction up to an edge-side delimitation of the floor structure. The transverse tunnel is implemented comparably to the central tunnel as a type of depression protruding upward into the floor structure. Through the embossment of the floor structure formed by the central tunnel and/or the transverse tunnel and by the arrangement and orientation of central tunnel and transverse tunnel, which are not oriented parallel to one another, but rather transversely, a structural stiffening of the entire floor structure can be achieved overall.

In particular, the transverse tunnel contributes to a wide-ranging stabilization of the floor structure. Central tunnel and transverse tunnel can be implemented from the same material as the floor plate adjoining the respective tunnel, for example. In particular, it is conceivable that central and transverse tunnels are implemented integrally with one another and integrally with adjoining floor plate sections. In particular, the central and/or the transverse tunnel can be brought into a required geometric shape by embossing a metal, in particular a steel or aluminum plate blank, or by a similar shaping process.

Because the floor plate experiences an inherent structural reinforcement by introducing multiple tunnel sections which protrude inward and/or upward, the remaining structure-reinforcing components of the floor structure, for example, longitudinal girders and/or side sills, can even be designed as somewhat weaker with respect to their respective load requirement profile in certain circumstances. Thus, for example, thinner-walled plates or lighter materials can increasingly be used for longitudinal girders and/or side sills, so that the total weight of the floor structure can advantageously be reduced.

According to an embodiment, it is provided that the transverse tunnel opens into the central tunnel. Alternatively thereto, the transverse tunnel can also butt up against the central tunnel, which is implemented as continuous in the vehicle longitudinal direction. If transverse tunnel and central tunnel open into one another, a transition of the troughs, which are formed by the central tunnel and transverse tunnel and protrude upward into the floor structure, can be provided, so that further vehicle components, for example, such as an exhaust system, can extend coming from the front via the central tunnel into the transverse tunnel and after it further to the rear, back to the vehicle rear. In this way, central tunnel and transverse tunnel can provide coherent storage space for motor vehicle components to be attached to the motor vehicle in the external area.

In a further embodiment, it is provided that the transverse tunnel extends essentially in the vehicle transverse direction (y). At least the transverse tunnel longitudinal extension has a directional component in the vehicle transverse direction, so that overall a configuration of transverse tunnel and central tunnel which stiffens the floor structure and is nonparallel results.

According to an embodiment, the transverse tunnel is additionally supported on the outside on a side sill of the floor structure. The transverse tunnel thus forms a structure-reinforcing connection of central tunnel and side sill. Therefore, a type of crossbeam can be seen in the at least one transverse tunnel, which increases the stability and torsional stiffness of the entire floor structure advantageously.

Thus, according to an embodiment, the central tunnel expands toward the front, pointing in the travel direction of the motor vehicle and also upward, to form a receptacle for a motor mounted at least partially in front of a front wall. The front central tunnel expansion provided as a receptacle or housing for the motor allows the motor of the motor vehicle, viewed in the travel direction, to be able to be displaced behind the front axle and/or even behind a transmission mounted in front of the motor. This central tunnel expansion thus forms a bay, housing, or depression protruding into the interior, into the passenger compartment of the vehicle, which allows the motor and/or an associated transmission, viewed in the vehicle longitudinal direction, to be situated further to the rear toward the vehicle center. In addition, a downwardly directed center of gravity displacement of the motor vehicle can accompany such positive influencing of the overall weight distribution of the motor vehicle.

According to a further embodiment, it is provided that at least two transverse tunnels, which are opposite to one another in the vehicle transverse direction, adjoin the central tunnel. Both transverse tunnels can preferably open into the central tunnel. The central tunnel and the two transverse tunnels thus form a cross-like structure. Furthermore, it can be provided that the central tunnel and the at least one transverse tunnel, preferably both transverse tunnels, have an essentially constant profile cross-section in the tunnel longitudinal direction. It is particularly provided in this case that the central tunnel extends continuously from the front wall or from the expansion on the front wall side up to a heel plate having an essentially constant cross-sectional profile. The tunnel profile is advantageously directly connected to the heel plate, viewed over its entire installation height in the vehicle vertical direction. In this rear area, the central tunnel can be used as a storage space for fuel or batteries, for example.

According to a further embodiment, the installation height of the at least one transverse tunnel, preferably both transverse tunnels, can decrease toward the outside, i.e., toward the side sills. The structural height of the transverse tunnel profile preferably decreases to the installation height of the laterally adjoining side sill. Any lateral forces to be transmitted from the transverse tunnel can thus be optimally introduced into the side sill structure.

According to a further embodiment, it is provided that the central tunnel and/or the at least one transverse tunnel have a trapezoidal cross-sectional profile. I.e., an upper area of central tunnel and/or transverse tunnel, located in the middle of the tunnel profile and offset in relation to the adjoining floor plate in the vehicle vertical direction, extends essentially parallel to the adjoining floor plate section. The transition between this raised inner tunnel section and adjoining floor plate is formed by cheek sections, which have at least one directional component along the vehicle vertical axis (z).

According to a further embodiment, the at least one transverse tunnel, viewed in the vehicle longitudinal direction, is situated below a vehicle front seat. The transverse tunnel can be implemented directly as a substructure for the motor vehicle seat and as a base for the installation of seat rails. Through the possibility provided by the floor structure, in particular by the frontal tunnel expansion, of situating the motor toward the vehicle center, viewed in the vehicle longitudinal direction, a concentration of vehicle mass in the lowermost central part of the vehicle can be achieved.

Overall, simpler and less branched structures and geometries of the motor vehicle body can be implemented proceeding there from. In addition, due to the cross-like branching of central tunnel and transverse tunnel, a floor structure which is stiffened per se can be provided, which overall allows a reduction of the vehicle body weight and thus the motor vehicle weight.

According to a further embodiment, a motor vehicle body is provided that is equipped with the above-described floor structure, the installation space formed by central tunnel and transverse tunnel and by frontal central tunnel expansion being provided to accommodate further motor vehicle components, in particular energy storage modules, such as one or more fuel tanks and/or vehicle bodies. The storage space thus formed in the floor structure of the motor vehicle is suitable in particular for receiving rechargeable batteries or storage batteries for hybrid vehicles or solely electrically-operated vehicles. In particular, the vehicle center of gravity, through the configuration of especially voluminous and correspondingly heavy battery packets in the central or transverse tunnel areas, can be used for displacing the vehicle center of gravity downward.

It is thus provided according to another embodiment that the motor vehicle body is alternately usable for a hybrid vehicle and also for a solely fuel-operated motor vehicle, i.e., which is solely equipped with an internal combustion engine, or alternatively for a solely electrically-operated motor vehicle. Depending on the selected type of drive, the storage space formed by central and transverse tunnels can alternately be used for accommodating vehicle batteries and/or fuel tanks.

In a further embodiment, a motor vehicle is provided having an above-described floor structure and having at least one energy storage module, which is at least regionally situated in the central tunnel and/or in at least one transverse tunnel. It can be provided according to a refinement in this case that the expansion of the central tunnel of the floor structure, which points forward, in the travel direction, at least regionally encloses a motor of the motor vehicle, in particular encompasses or regionally encloses an internal combustion engine, whose crankshaft is oriented essentially in the vehicle transverse direction and which is situated behind a transmission, viewed in the travel direction of the vehicle.

### BRIEF DESCRIPTION OF THE FIGURES

The present invention will hereinafter be described in conjunction with the following drawing figures, wherein like numerals denote like elements, and:

FIG. 1 is shows a schematic view of a floor structure in horizontal projection from below;

FIG. 2 is shows the floor structure according to FIG. 1 with additional front frame and lateral longitudinal girders fastened thereon;

FIG. 3 is shows a further view of the floor structure according to FIG. 2 with drive assembly;

FIG. 4 is shows a schematic and perspective view of the floor structure seen diagonally from the rear; and

FIG. 5 is shows a further perspective view of the floor structure according to FIG. 4 without the side sills shown therein.

### DETAILED DESCRIPTION

The following detailed description is merely exemplary in nature and is not intended to limit application and uses. Furthermore, there is no intention to be bound by any theory presented in the preceding background or summary or the following detailed description.

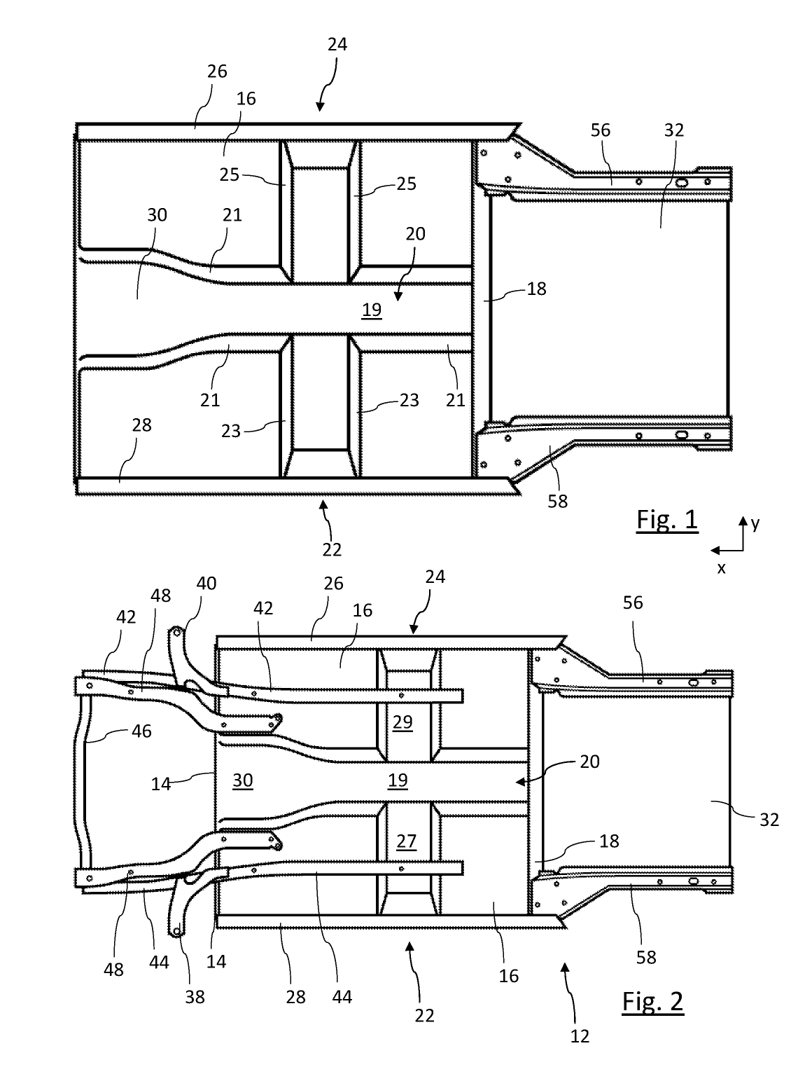

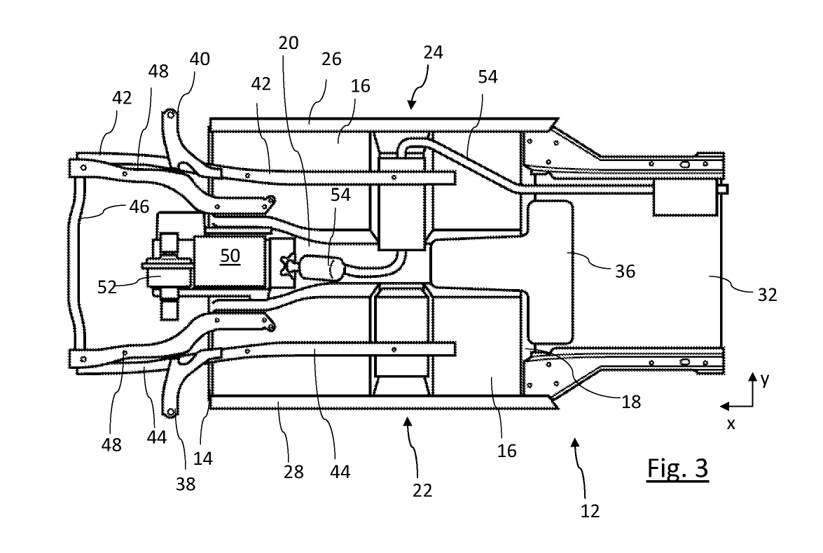

FIG. 1 to FIG. 3 show the floor structure of a motor vehicle body 12, preferably a self-supporting vehicle body, viewed from below. In FIG. 3, the location of the motor 50 and a transmission 52 operationally linked thereto are shown. The vehicle body 12 has a floor structure formed in the form of a floor plate 16, which merges into an upwardly protruding front wall 14, in the front in the travel direction, and into a cargo floor 32 to the rear via a heel plate 18.

In the area between front wall 14 and heel plate 18, in which the passenger compartment of the vehicle is also located, the vehicle body 12 has a cross-like tunnel structure 20, 22, 24. Thus, a central tunnel extends in the vehicle longitudinal direction (x) from the front wall 14 up to the heel plate 18. Two transverse tunnels 22, 24 are provided in the vehicle transverse direction (y), the right transverse tunnel 22 adjoining the central tunnel 20 on the left and a right side sill 28 on the right. Correspondingly, the left transverse tunnel 24 adjoins the central tunnel 20 on the right and the left side sill 26 on the left. The central tunnel 20 merges to the front, toward the front wall 14, into a tunnel expansion 30, which can be implemented integrally with the front wall 14 and/or with the central tunnel 20.

The tunnel expansion 30 is used as a housing and receptacle for the motor 50 schematically shown in FIG. 2 which, viewed in the travel direction of the vehicle, is situated displaced toward the vehicle center, located behind the transmission 52 mounted in front. In addition, in this embodiment, the motor 50 is located behind the front axle of the motor vehicle, which simultaneously functions as a drive axle in the present exemplary embodiment, in relation to the travel direction of the vehicle. The location of the front axle is indicated by the body-side wheel mounts 38, 40, which are in turn fastened on the longitudinal girders 42, 44 of the vehicle body.

The motor 50 or the drive unit formed by motor 50 and transmission 52 is suspended on a sub frame 48, preferably decoupled from vibration, which is located, viewed in the vehicle transverse direction, inside or between the two longitudinal girders 42, 44. Longitudinal girders 42, 44 and/or sub frame components 48 can further be connected to one another in this case via a crossbeam 46.

In an alternative view, the floor plate 16, viewed in the vehicle transverse direction (y), is interrupted by a central tunnel 20 extending essentially in the vehicle longitudinal direction (x) in a corresponding way, the floor plate 16 is further penetrated, viewed in the vehicle longitudinal direction (x), by a transverse tunnel 22, 24 extending in the vehicle transverse direction (y). Central or longitudinal tunnel 20 and transverse tunnels 22, 24 open directly into one another. I.e., the side cheek sections 21 of the central tunnel 20 merge seamlessly into corresponding side cheek sections 23, 25 of the corresponding transverse tunnel sections 22, 24.

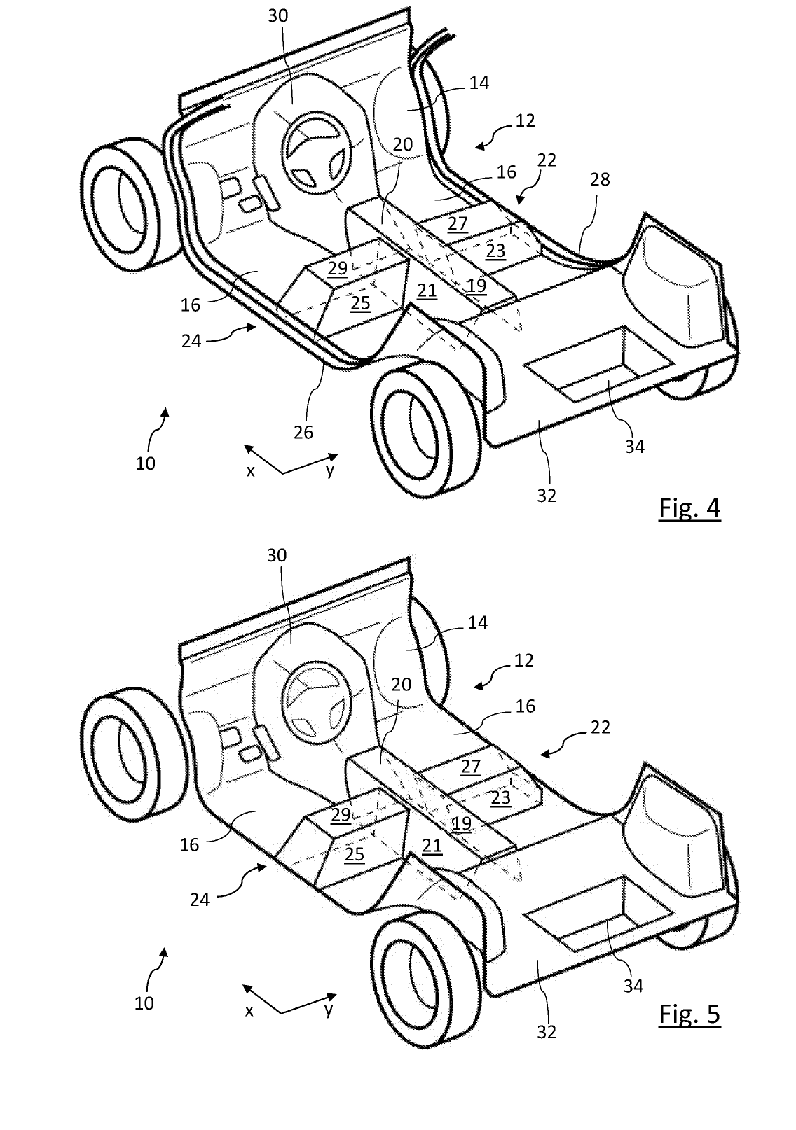

Furthermore, the longitudinal and transverse tunnels 20, 22, 24 have a trapezoidal design in cross-section, as is clear from the perspective view of a motor vehicle substructure 10 according to FIG. 4 and FIG. 5, for example. The central or upper floor sections 19, 27, 29 of central tunnel 20 and transverse tunnel 22, 24 extend in a plane essentially parallel to the floor plate 16 in this case, which adjoins sections of the tunnels 20, 22, 24. The inner or upper floor sections of the middle and transverse tunnels 20, 22, 24, which are implemented as trapezoidal in cross-section, are nearly in a common plane, which is offset vertically upward to the floor plate. The central tunnel 20 extends with an essentially uniform cross-sectional profile continuously from a frontal central tunnel expansion 30 up to the heel plate 18. The central tunnel 20 is advantageously directly connected at a rear end section, facing toward the vehicle rear, to the heel plate 18.

Two longitudinal girders 56, 58 of the rear frame are provided laterally adjoining the heel plate to the rear, between which the cargo floor 32 stretches, which furthermore has a spare wheel trough 34, which can also be used to receive one or more energy storage modules, such as a vehicle battery, instead of a spare wheel. Overall, a transverse stiffening of the entire floor structure can be achieved by the cross-like structure of central tunnel 20 and transverse tunnels 22, 24. The structure-stiffening effect of the two transverse tunnels 22, 24 can additionally be reinforced by their load-dissipating attachment to the respective side sills 26, 28. The central tunnel expansion 30 adjoining the central tunnel to the front additionally allows a displacement of the drive assembly toward the vehicle center, so that motor and/or transmission can be situated in the motor vehicle located behind a front axle.

It is particularly provided in this case, if the motor vehicle is equipped with an internal combustion engine, that it is installed in the transverse direction of the vehicle, so that the crankshaft of the motor 50 is essentially in the vehicle transverse direction. The transmission 52 is located mounted in front of the motor and is preferably implemented as a so-called continuously variable transmission (CVT). For the case in which the floor structure or the entire motor vehicle body is to be provided for a hybrid vehicle or a solely electrically-operated vehicle, the central tunnel 20, 30 extending continuously from the heel plate 18 up to the front wall 14 can be used to receive a vehicle battery, which is accordingly implemented as long. Since the batteries of an electrical vehicle substantially contribute to its total weight and furthermore, by dispensing with an internal combustion engine, the weight distribution of an electric vehicle is entirely different in comparison to a vehicle having internal combustion engine, by this accommodation of vehicle batteries integrated in the floor structure, a configuration can be provided which is both more crash-safe and improved with respect to weight distribution and center of gravity location of the vehicle.

The configuration of an internal combustion engine protruding into the central tunnel section 30, 20, as shown in FIG. 3, further proves to be advantageous for the crash behavior of the motor vehicle, since in this way the vehicle body structure will now primarily dissipate or optionally relay collision-related energy in its external areas, but must provide an increasingly less structure-stiffening and retaining function for a motor situated in the vehicle front area, for example.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A floor structure of a motor vehicle body, comprising:
a central tunnel that extends essentially in a vehicle longitudinal direction and protrudes upward in a direction of a passenger compartment located above the central tunnel; and
a transverse tunnel that extends transversely to the central tunnel and extends from the central tunnel up to an edge located in a vehicle transverse direction.

2. The floor structure according to claim 1, wherein the transverse tunnel opens into the central tunnel.

3. The floor structure according to claim 1, wherein the transverse tunnel extends essentially in the vehicle transverse direction.

4. The floor structure according to claim 1, wherein the transverse tunnel is supported toward an outside in the vehicle transverse direction on a side sill.

5. The floor structure according to claim 1, wherein the central tunnel expands toward a front in a travel direction and upward into a receptacle for a motor at least sectionally mounted in front of a front wall.

6. The floor structure according to claim 1, wherein a first transverse tunnel opposing a second transverse tunnel in the vehicle transverse direction and adjoin the central tunnel.

7. The floor structure according to claim 1, wherein the central tunnel and the transverse tunnel have an essentially constant profile cross-section in a tunnel longitudinal direction.

8. The floor structure according to claim 1, wherein an installation height of the transverse tunnel decreases outward.

9. The floor structure according to claim 1, wherein the central tunnel extends continuously from a front wall up to a heel plate.

10. The floor structure according to claim 1, wherein the central tunnel has a trapezoidal cross-sectional profile.

11. The floor structure according to claim 1, wherein the transverse tunnel have a trapezoidal cross-sectional profile.

12. The floor structure according to claim 1, wherein the transverse tunnel is situated below a vehicle front seat viewed in the vehicle longitudinal direction.

13. The floor structure according to claim 1, further comprising an energy storage module that is at least regionally situated in the central tunnel and/or in at least one transverse tunnel.

14. The floor structure according to claim 1, further comprising an energy storage module that is at least regionally situated in the transverse tunnel.

15. The floor structure according to claim 13, wherein an expansion of the central tunnel pointing forward in a travel direction that at least regionally encompasses a motor having a crankshaft oriented essentially in the vehicle transverse direction and situated behind a transmission that is operationally linked to the motor in relation to the travel direction.

16. The floor structure according to claim 14, wherein an expansion of the central tunnel pointing forward in a travel direction that at least regionally encompasses a motor having a crankshaft oriented essentially in the vehicle transverse direction and situated behind a transmission that is operationally linked to the motor in relation to the travel direction.
